(19) United States
(12) Patent Application Publication
(10) Pub. No.: US 2007/0017566 A1
(43) Pub. Date: Jan. 25, 2007

(54) Flexible photovoltaic modules

(76) Inventors: Russell Gaudiana, Merrimack, NH (US); Daniel Patrick McGahn, Boston, MA (US)

Correspondence Address: FISH & RICHARDSON PC, P.O. BOX 1022, MINNEAPOLIS, MN, 55440-1022, US

(21) Appl. No.: 11/451,873

(22) Filed: Jun. 13, 2006

Related U.S. Application Data
(60) Provisional application No. 60/689,955, filed on Jun. 13, 2005.

(51) Int. Cl. H02N 6/00

(52) U.S. Cl. 136/245

(57) ABSTRACT

Flexible photovoltaic modules, as well as related systems, methods, and components are disclosed.

### CROSS REFERENCE TO RELATED APPLICATION

This application claims priority to U.S. Provisional Application Ser. No. 60/689,955, filed Jun. 13, 2005, the contents of which are hereby incorporated by reference.

### TECHNICAL FIELD

This disclosure relates to flexible photovoltaic modules, as well as related systems, methods, and components.

### BACKGROUND

Flat and rigid panels of crystalline silicon have been used in photovoltaic cells to convert solar energy to electrical energy. Such cells are generally mounted or tethered to a lamp or a battery. However, photovoltaic cells containing crystalline silicon can be relatively heavy and brittle.

### SUMMARY

This disclosure relates to photovoltaic modules, as well as related systems, methods, and components.

In one aspect, the invention features an illuminating device containing a housing having a curved outer surface; and a flexible photovoltaic module disposed on at least a portion of the curved outer surface of the housing.

Embodiments can include one or more of the following aspects.

In some embodiments, the housing is cylindrical. In certain embodiments, the entire curved outer surface of the housing is covered by a flexible photovoltaic module. In other embodiments, the housing is made of a flexible photovoltaic module.

In some embodiments, the housing can have one or more openings through which light is emitted. In certain embodiments, the housing is removed so the light emitted from a bulb in the housing can be used for illumination.

In some embodiments, the flexible photovoltaic module includes a flexible substrate. The flexible substrate can have a flexural modulus of less than about 5,000 megaPascals. In certain embodiments, the flexible substrate includes a polymer selected from polyethylene terephthalates, polyethylene naphthalates, polyethylenes, polypropylenes, polyamides, polymethacrylates, polycarbonates, polyurethanes, and combinations thereof.

In some embodiments, the flexible photovoltaic module includes a plurality of photovoltaic cells, at least some of which are electrically connected. At least some of the plurality of photovoltaic cells can be dye sensitized photovoltaic cells, organic photovoltaic cells, or amorphous silicon photovoltaic cells. In certain embodiments, at least some of the dye sensitized photovoltaic cells include titania.

In some embodiments, at least some of the plurality of photovoltaic cells can be tandem photovoltaic cells.

In some embodiments, the flexible photovoltaic module includes a plurality of dyes arranged in a pattern. The pattern can include a camouflage pattern or a logo pattern. In certain embodiments, at least some of the plurality of dyes have a different color.

In some embodiments, the flexible photovoltaic module has an efficiency of at least about 5% (e.g., at least about 7% or at least about 10%).

In some embodiments, the illuminating device further includes a rechargeable battery in the housing. In certain embodiments, the flexible photovoltaic module is configured to recharge the rechargeable battery.

In some embodiments, the illuminating device includes a portable lamp, a flashlight, a lantern, a signage, a landscape light, a buoy light, or a traffic light.

Other features and advantages will be apparent from the description, drawings and from the claims.

### DESCRIPTION OF DRAWINGS

FIG. 1(a) is a top view of a photovoltaic cell.

FIG. 1(b) is a top view of a 3-module photovoltaic array containing eleven photovoltaic cells per module.

FIG. 1(c) is a schematic of a 3-module photovoltaic array configured as a cylinder.

FIG. 2(a) is a schematic of a photovoltaic array tethered to a portable lamp.

FIG. 2(b) is a schematic of a photovoltaic array incorporated in a curved housing of a portable lamp.

FIG. 2(c) is a schematic of a photovoltaic array incorporated in a cylindrical housing of a portable lamp.

FIG. 3 is a top view of a 3-module photovoltaic array having a camouflage pattern.

FIG. 4 is a top view of a patterned photoactive layer of a photovoltaic cell.

FIG. 5 is a cross-sectional view of the photovoltaic cell of FIG. 4.

FIG. 6 is a schematic of a process for manufacturing a patterned photovoltaic cell.

FIG. 7 is a top view of a patterned photoactive layer of a photovoltaic cell.

FIG. 8 is a cross-sectional view of the photovoltaic cell of FIG. 7.

FIG. 9 is a schematic of a system containing one electrode between two photoactive layers.

FIG. 10 is a schematic of a 3-module photovoltaic array disposed on the outer surface of a cylindrical housing of a lamp.

FIG. 11 is a schematic showing a 2-inch direct exposure area of the 3-module photovoltaic array of FIG. 10.

Like reference symbols in the various drawings indicate like elements.

### DETAILED DESCRIPTION

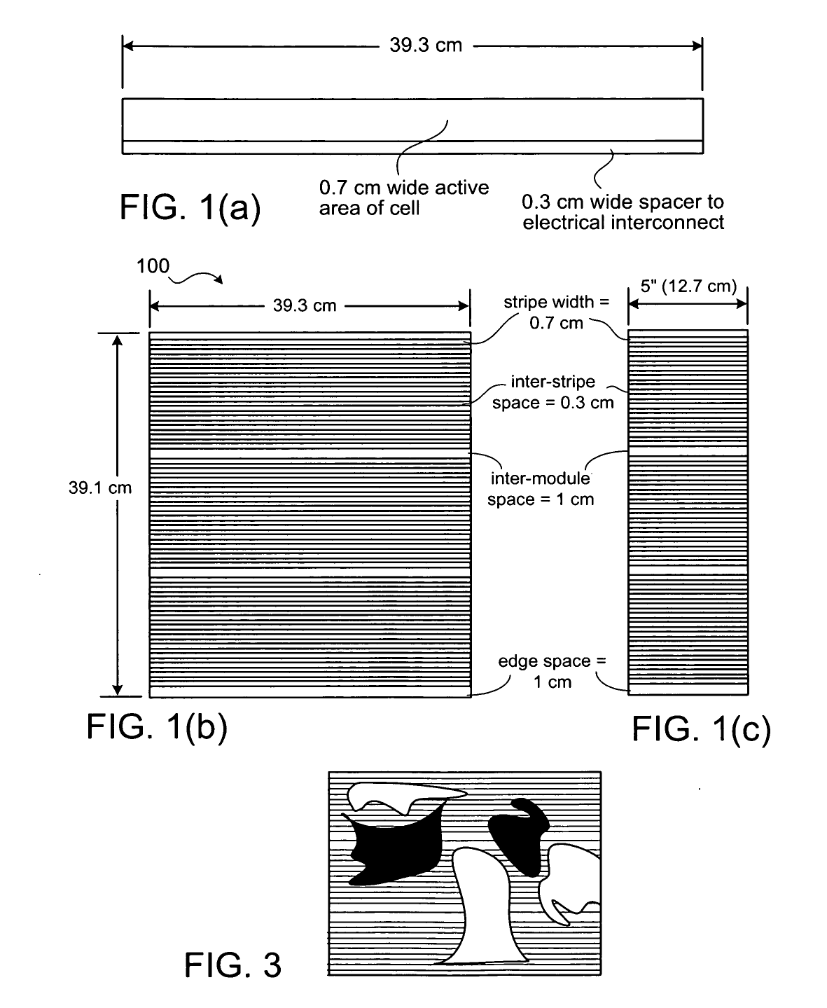

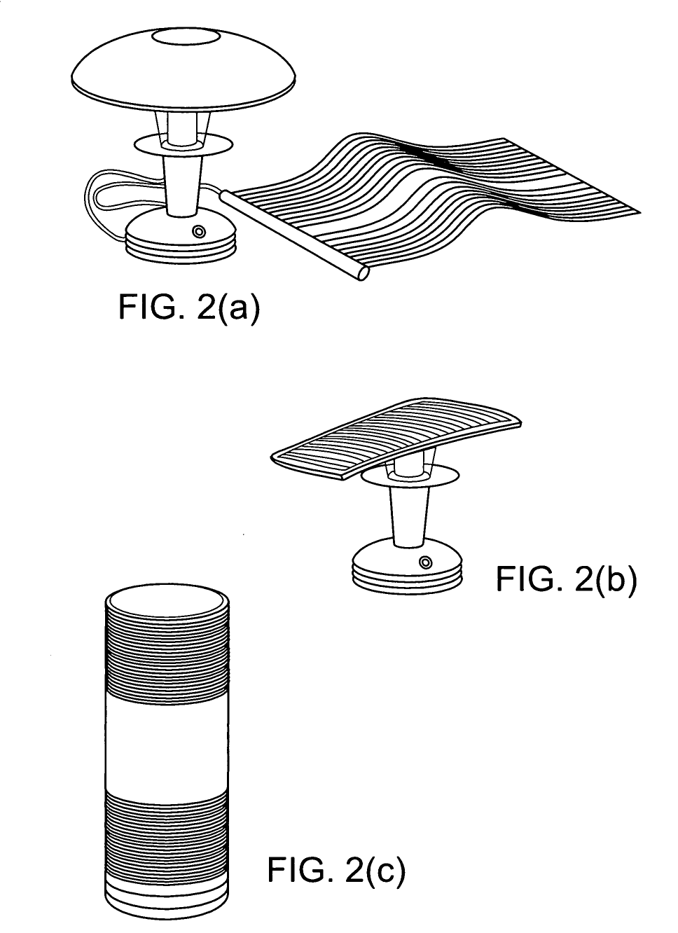

FIG. 1(a) shows a top view of an embodiment of a flexible photovoltaic cell. The photovoltaic cell is 39.3 cm long and 1 cm wide. The active area and inactive area (for electrical interconnection) of the photovoltaic cell are 0.7 cm wide and 0.3 cm wide respectively. FIG. 1(b) shows a top view of an embodiment of a 3-module array 100 containing eleven photovoltaic cells (in the shape of a strip) per module. The module is 39.3 cm long and 39.1 cm wide. Each photovoltaic cell has an active area that is 0.7 cm wide. The module has an inter-stripe space of 0.7 cm wide, an inter-module space of 1 cm wide, and an edge space of 1 cm wide. FIG. 1(c) shows a schematic of a 3-module array 100 shown in FIG. 2 that is configured as a cylinder having a diameter of 12.7 cm.

In some embodiments, array 100 can be disposed on at least a portion of a curved outer surface of a housing (e.g., a cylindrical housing) of an illuminating device (e.g., a portable lamp or a flashlight). In general, during daylight hours, the photovoltaic cells in array 100 can absorb incident radiation from direct exposure to sunlight, as well as diffuse radiation from the environment. The absorbed solar energy can then be converted to the electrical energy by the photovoltaic cells and stored in a rechargeable battery in the illuminating device. The illuminating device does not have to be oriented toward the sun (e.g., tracking the path of the sun is not required). The illuminating device can be carried by hand, attached to a backpack, or mounted to an outer surface of a vehicle. FIGS. 2(a), (b), and (c) show a photovoltaic array incorporated in a portable lamp or tethered to a portable lamp.

In some embodiments, array 100 can contain at least one module (e.g., at least two modules, at least three modules, or at least for modules). Each module can contain at least one photovoltaic cell (e.g., at least 5 photovoltaic cells, at least 10 photovoltaic cells, or at least 15 photovoltaic cells). Photovoltaic cells can be electrically connected in series or in parallel. In certain embodiments, some photovoltaic cells are electrically connected in series, and some of the photovoltaic cells are electrically connected in parallel.

While shown in FIG. 1(a) as having a rectangular shape, a photovoltaic cell can generally have any desired shape (e.g., square, circle, semicircle, triangle, diamond, ellipse, trapezoid, irregular shape). In some embodiments, different photovoltaic cells in array 100 can have different shapes.

In some embodiments, array 100 can be disposed on a flexible substrate, such as a substrate having a flexural modulus of less than about 5,000 megaPascals (e.g., less than about 2,500 megaPascals or less than about 1,000 megapascals). The flexible substrate can be prepared from a polymer selected from the group consisting of polyethylene terephthalates, polyethylene naphthalates, polyethylenes, polypropylenes, polyamides, polymethacrylates, polycarbonates, polyurethanes, and combinations thereof.

In some embodiments, array 100 can include a plurality of dye sensitized photovoltaic cells. The dye sensitized photovoltaic cells can include dyes arranged in a pattern (e.g., a camouflage pattern or a logo pattern) in photoactive layers (e.g., layers containing titania or amorphous silicon) of the cells. FIG. 3 shows a 3-module array having a camouflage pattern.

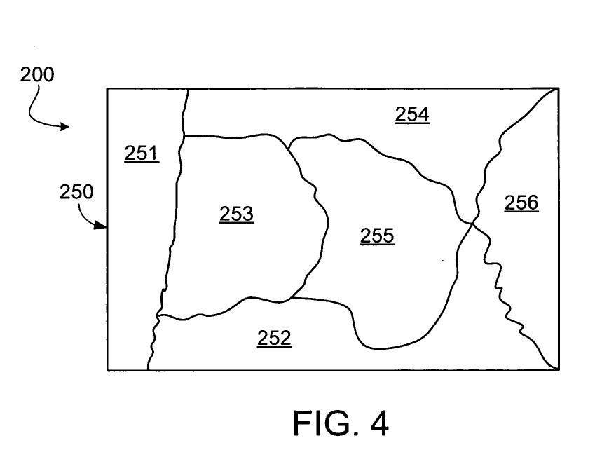

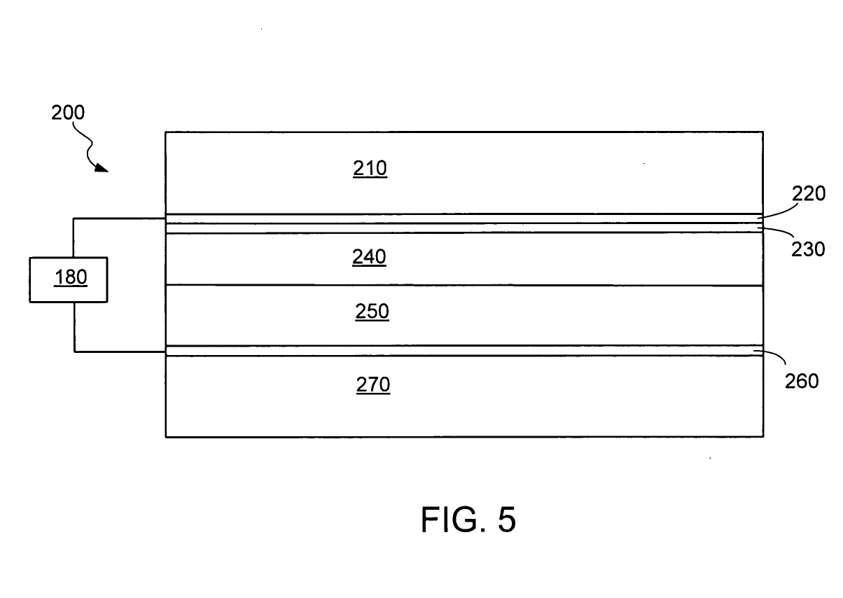

FIG. 4 is a top view of a photoactive layer 250 of a dye sensitized solar cell (DSSC) 200, and FIG. 5 is a cross-sectional view of DSSC 200. Photoactive layer 250 includes regions 251-256 that form a pattern (e.g., a camouflage pattern or a logo pattern). The pattern results from at least some of the regions being of different color. In some embodiments, each of regions 251-256 has a different color. More generally, however, at least two of regions 251-256 (e.g., at least three of regions, at least four of the regions, at least five of the regions) have a different color.

In general, a pattern can be generated by printing one or more dyes on the photoactive layers of the cells. For example, dyes can be printed on the photoactive layers using dip coating, extrusion coating, spray coating, inkjet printing, screen printing, and gravure printing.

In general, the color of each region 251-156 is determined by the particular dye (or combination of dyes) contained within the given region. Examples of dyes include black dyes (e.g., tris(isothiocyanato)-ruthenium (II)-2,2′:6′,2″-terpyridine-4,4′,4″-tricarboxylic acid, tris-tetrabutylammonium salt), orange dyes (e.g., tris(2,2′-bipyridyl-4,4′-dicarboxylato) ruthenium (II) dichloride, purple dyes (e.g., cis-bis(isothiocyanato)bis-(2,2′-bipyridyl-4,4′-dicarboxylato)-ruthenium (II)), red dyes (e.g., an eosin), green dyes (e.g., a merocyanine) and blue dyes (e.g., a cyanine). Examples of additional dyes include indolines, thiophenes, coumarins, anthocyanines, porphyrins, phthalocyanines, squarates, and certain metal-containing dyes. Combinations of dyes can also be used within a given region so that a given region can include more than one (e.g., two, three, four, five, six, seven) different dyes.

In some embodiments, photoactive layer 250 can include a dye having a formula cis-RuLL′(NCS)₂, in which L can include a first 2,2′-bipyridyl and L′ can include a second 2,2′-bipyridyl. The first 2,2′-bipyridyl can be the same as or can be different from the second 2,2′-bipyridyl. The term “2,2′-bipyridal” mentioned herein includes both substituted and unsubstituted moieties. Examples of substituents include C₁-C₁₀ alkyl, C₂-C₁₀ alkenyl, C₂-C₁₀ alkynyl, C₃-C₈ cycloalkyl, C₅-C₈ cycloalkenyl, C₁-C₁₀ alkoxy, aryl, aryloxy, heteroaryl, heteroaryloxy, amino, C₁-C₁₀ alkylamino, C₁-C₂₀ dialkylamino, arylamino, diarylamino, heteroarylamino, diheteroarylamino, C₁-C₁₀ alkylsulfonyl, arylsulfonyl, heteroarylsulfonyl, C₁-C₁₀ alkylsulfonamide, arylsulfonamide, heteroarylsulfonamide, hydroxyl, halogen, mercapto, C₁-C₁₀ alkylmercapto, arylmercapto, cyano, nitro, acyl, acyloxy, carboxyl, amido, carbamoyl, and carboxylic ester. Cycloalkyl, heterocycloalkyl, aryl, and heteroaryl also include fused groups.

An example of cis-RuLL′(NCS)₂ is cis-Ru(4,4′-dicarboxylic acid-2,2′-bipyridyl)(4,4′-dinonyl-2,2′-bipyridyl)(NCS)₂ (Z907). In certain embodiments, Z907 is first dissolved in a suitable organic solvent to form a dye solution. The organic solvent typically has low vapor pressure (e.g., <10 mmHg at 20° C.), good dye solubility (e.g., dissolving more than 5 mM of the dye), high permittivity and wettability to the semiconductor material in a photoactive layer (e.g., TiO₂ nanoparticles), thereby facilitating dye absorbance to the semiconductor material and reducing the dyeing time. Examples of such organic solvents include g-butyrolactone, 1-methoxy-2-propanol, N,N-dimethyl formamide, N,N-dimethylacetamide, propylene glycol phenyl ether, and a mixture thereof. The dye solution can then be applied to a semiconductor material by one or more methods disclosed herein. The dyeing process using such a dye solution can have a relatively short dyeing time. In certain embodiments, by using a dyeing solution mentioned above, 65 mg of Z907 can be absorbed onto 1 g of the semiconductor material in at most about 5 minutes, (e.g., at most about 4 minutes, at most about 3 minutes, at most about 2 minutes, or at most about 1 minute).

In some embodiments, a thickening agent can be added to a solution containing a dye (e.g., a ruthenium based dye such as Z907 or an organic dye). The thickening agent can reduce the dyeing time. It can also be used to adjust the rheology (e.g., the viscosity) of the dye solution by using different concentrations. Exemplary thickening agents include dispensible fumed silica particles and poly(propylene glycol). After the dye is absorbed onto a semiconductor material, the thickening agent can be optionally removed by washing the semiconductor material with an organic solvent (e.g., ethanol or 1-methoxy-2-propanol).

In some embodiments, the fumed silica particles can be modified to form a hydrophobic surface. For example, the surface of the fumed silica particles can be modified with poly(dimethyl siloxane) moieties. An example of such a hydrophobic silica is CAB-O-SIL TS-720 manufactured by CABOT CORPORATION. Hydrophobic silica particles can improve the thermal stability of a photovoltaic cell. Without wishing to be bound by theory, it is believed that hydrophobic silica particles can minimize the contact between the dye and the electrolyte in the photovoltaic cell, thereby reducing dye desorption.

Photoactive layer 250 also includes an additional material, such as a semiconductor material, that is associated with the dyes. Examples of semiconductor materials include materials having the formula MₓO_{y} where M may be, for example, titanium, zirconium, tungsten, niobium, lanthanum, tantalum, terbium, or tin and x and y are integers greater than zero. Other suitable materials include sulfides, selenides, tellurides, and oxides of titanium, zirconium, tungsten, niobium, lanthanum, tantalum, terbium, tin, or combinations thereof. For example, TiO₂, SrTiO₃, CaTiO₃, ZrO₂, WO₃, La₂O₃, Nb₂O₅, SnO₂, sodium titanate, cadmium selenide (CdSe), cadmium sulphides, and potassium niobate may be suitable materials.

Typically, the semiconductor material contained within layer 250 is in the form of nanoparticles. In some embodiments, the nanoparticles have an average size between about two nm and about 100 nm (e.g., between about 10 nm and 40 nm, such as about 20 nm).

The nanoparticles can be interconnected, for example, by high temperature sintering, or by a reactive polymeric linking agent, such as poly(n-butyl titanate). A polymeric linking agent can enable the fabrication of an interconnected nanoparticle layer at relatively low temperatures (e.g., less than about 300° C.) and in some embodiments at room temperature. The relatively low temperature interconnection process may be amenable to continuous manufacturing processes using polymer substrates.

The interconnected nanoparticles are generally photosensitized by the dye(s). The dyes facilitates conversion of incident light into electricity to produce the desired photovoltaic effect. It is believed that a dye absorbs incident light resulting in the excitation of electrons in the dye. The energy of the excited electrons is then transferred from the excitation levels of the dye into a conduction band of the interconnected nanoparticles. This electron transfer results in an effective separation of charge and the desired photovoltaic effect. Accordingly, the electrons in the conduction band of the interconnected nanoparticles are made available to drive an external load.

The dye(s) can be sorbed (e.g., chemisorbed and/or physisorbed) on the nanoparticles. A dye can be selected, for example, based on its ability to absorb photons in a wavelength range of operation (e.g., within the visible spectrum), its ability to produce free electrons (or electron holes) in a conduction band of the nanoparticles, its effectiveness in complexing with or sorbing to the nanoparticles, and/or its color.

Turning now to other components of DSSC 200, the composition and thickness of electrically conductive layer 220 is generally selected based on desired electrical conductivity, optical properties, and/or mechanical properties of the layer. In some embodiments, layer 220 is transparent. Examples of transparent materials suitable for forming such a layer include certain metal oxides, such as indium tin oxide (ITO), tin oxide, and a fluorine-doped tin oxide. In some embodiments, electrically conductive layer 220 can be formed of a foil (e.g., a titanium foil). Electrically conductive layer 220 may be, for example, between about 100 nm and 500 nm thick, (e.g., between about 150 nm and 300 nm thick).

In embodiments where counter electrode 260 is not transparent, electrically conductive layer 220 can be opaque (i.e., can transmit less than about 10% of the visible spectrum energy incident thereon). For example, layer 220 can be formed from a continuous layer of an opaque metal, such as copper, aluminum, indium, or gold.

In some embodiments, electrically conductive layer 220 can include a discontinuous layer of a conductive material. For example, electrically conductive layer 220 can include an electrically conducting mesh. Suitable mesh materials include metals, such as palladium, titanium, platinum, stainless steels and alloys thereof. In some embodiments, the mesh material includes a metal wire. The electrically conductive mesh material can also include an electrically insulating material that has been coated with an electrically conducting material, such as a metal. The electrically insulating material can include a fiber, such as a textile fiber or monofilament. Examples of fibers include synthetic polymeric fibers (e.g., nylons) and natural fibers (e.g., flax, cotton, wool, and silk). The mesh electrode can be flexible to facilitate, for example, formation of the DSSC by a continuous manufacturing process. Photovoltaic cells having mesh electrodes are disclosed, for example, in co-pending U.S. Patent Application Publication No. 2003/0230337, U.S. Patent Application Publication No. 2004/0187911, and International Patent Application Publication Number WO 03/04117, each of which is hereby incorporated by reference.

The mesh electrode may take a wide variety of forms with respect to, for example, wire (or fiber) diameters and mesh densities (i.e., the number of wires (or fibers) per unit area of the mesh). The mesh can be, for example, regular or irregular, with any number of opening shapes. Mesh form factors (such as, e.g., wire diameter and mesh density) can be chosen, for example, based on the conductivity of the wire (or fibers) of the mesh, the desired optical transmissivity, flexibility, and/or mechanical strength. Typically, the mesh electrode includes a wire (or fiber) mesh with an average wire (or fiber) diameter in the range from about one micron to about 400 microns, and an average open area between wires (or fibers) in the range from about 60% to about 95%.

Catalyst layer 230 is generally formed of a material that can catalyze a redox reaction in the charge carrier layer positioned below. Examples of materials from which catalyst layer can be formed include platinum and poly(3,4-ethylenedioxythiophene) (PEDOT). PEDOT layers are discussed in U.S. Patent Application Publication No. 2005/0045851, which is hereby incorporated by reference. Materials can be selected based on criteria such as, e.g., their compatibility with manufacturing processes, long term stability, and optical properties. In general, the catalyst layer is substantially transparent. However, in certain embodiments, (e.g., embodiments in which the cathodes are substantially transparent) the catalyst layer can be substantially opaque.

Substrate 210 can be formed from a mechanically-flexible material, such as a flexible polymer, or a rigid material, such as a glass. Examples of polymers that can be used to form a flexible substrate include polyethylene naphthalates, polyethylene terephthalates, polyethyelenes, polypropylenes, polyamides, polymethylmethacrylate, polycarbonate, and/or polyurethanes. Flexible substrates can facilitate continuous manufacturing processes such as web-based coating and lamination.

The thickness of substrate 210 can vary as desired. Typically, substrate thickness and type are selected to provide mechanical support sufficient for the DSSC to withstand the rigors of manufacturing, deployment, and use. Substrate 210 can have a thickness of from about six microns to about 5,000 microns (e.g., from about 6 microns to about 50 microns, from about 50 microns to about 5,000 microns, from about 100 microns to about 1,000 microns).

In embodiments where the counter electrode is transparent, substrate 210 is formed from a transparent material. For example, substrate 210 can be formed from a transparent glass or polymer, such as a silica-based glass or a polymer, such as those listed above. In such embodiments, electrically conductive layer 220 should also be transparent.

Substrate 270 and electrically conductive layer 260 can be similar to substrate 210 and electrically conductive layer 220, respectively. For example, substrate 270 can be formed from the same materials and can have the same thickness as substrate 210. In some embodiments however, it may be desirable for substrate 270 to be different from 210 in one or more aspects. For example, where the DSSC is manufactured using a process that places different stresses on the different substrates, it may be desirable for substrate 270 to be more or less mechanically robust than substrate 210. Accordingly, substrate 270 may be formed from a different material, or may have a different thickness that substrate 210. Furthermore, in embodiments where only one substrate is exposed to an illumination source during use, it is not necessary for both substrates and/or electrically conducting layers to be transparent. Accordingly, one of substrates and/or corresponding electrically conducting layer can be opaque.

As discussed previously, charge carrier layer 240 includes a material that facilitates the transfer of electrical charge from a ground potential or a current source to photoactive layer 250. A general class of suitable charge carrier materials include solvent-based liquid electrolytes, polyelectrolytes, polymeric electrolytes, solid electrolytes, n-type and p-type transporting materials (e.g., conducting polymers) and gel electrolytes. Other choices for charge carrier media are possible. For example, the charge carrier layer can include a lithium salt that has the formula LiX, where X is an iodide, bromide, chloride, perchlorate, thiocyanate, trifluoromethyl sulfonate, or hexafluorophosphate.

The charge carrier media typically includes a redox system. Suitable redox systems may include organic and/or inorganic redox systems. Examples of such systems include cerium(III) sulphate/cerium(IV), sodium bromide/bromine, lithium iodide/iodine, Fe²⁺/Fe³⁺, Co²⁺/Co³⁺, and viologens. Furthermore, an electrolyte solution may have the formula MᵢXⱼ, where i and j are greater than or equal to one, where X is an anion, and M is lithium, copper, barium, zinc, nickel, a lanthanide, cobalt, calcium, aluminum, or magnesium. Suitable anions include chloride, perchlorate, thiocyanate, trifluoromethyl sulfonate, and hexafluorophosphate.

In some embodiments, the charge carrier media includes a polymeric electrolyte. For example, the polymeric electrolyte can include poly(vinyl imidazolium halide) and lithium iodide and/or polyvinyl pyridinium salts. In embodiments, the charge carrier media can include a solid electrolyte, such as lithium iodide, pyridimum iodide, and/or substituted imidazolium iodide.

The charge carrier media can include various types of polymeric polyelectrolytes. For example, suitable polyelectrolytes can include between about 5% and about 95% (e.g., 5-60%, 5-40%, or 5-20%) by weight of a polymer, e.g., an ion-conducting polymer, and about 5% to about 95% (e.g., about 35-95%, 60-95%, or 80-95%) by weight of a plasticizer, about 0.05 M to about 10 M of a redox electrolyte of organic or inorganic iodides (e.g., about 0.05-2 M, 0.05-1 M, or 0.05-0.5 M), and about 0.01 M to about 1 M (e.g., about 0.05-0.5 M, 0.05-0.2 M, or 0.05-0.1 M) of iodine. The ion-conducting polymer may include, for example, polyethylene oxide (PEO), polyacrylonitrile (PAN), polymethylmethacrylate (PMMA), polyethers, and polyphenols. Examples of suitable plasticizers include ethyl carbonate, propylene carbonate, mixtures of carbonates, organic phosphates, butyrolactone, and dialkylphthalates.

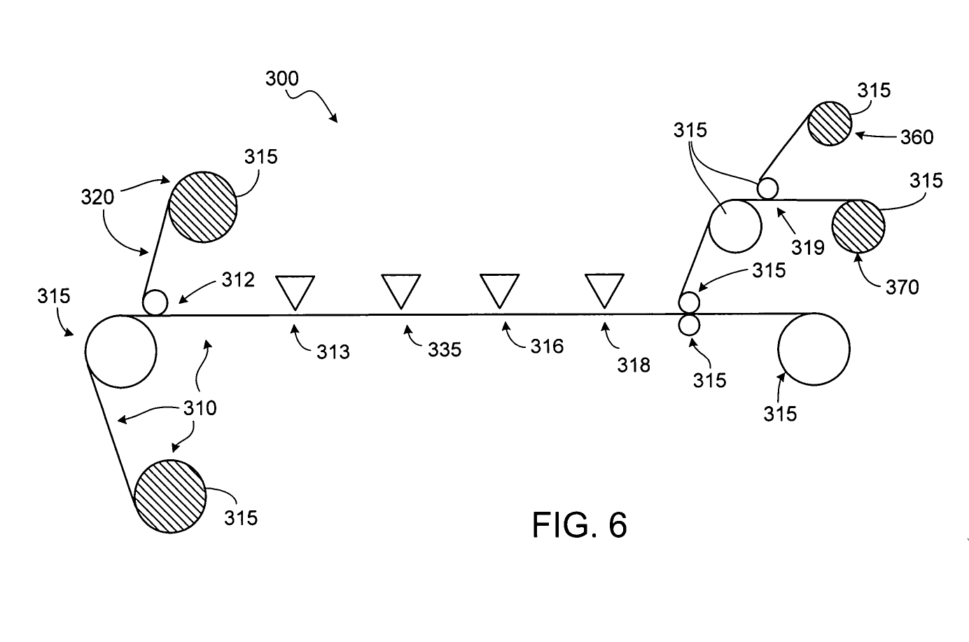

FIG. 6 shows a process (a roll-to-roll process) 300 for manufacturing a patterned photovoltaic cell by advancing a substrate 310 between rollers 315. Substrate 310 can be advanced between rollers 315 continuously, periodically, or irregularly during a manufacturing run.

An electrically conductive layer 320 (e.g., a titanium foil) is attached to substrate 310 adjacent location 312.

An interconnected nanoparticle material is then formed on the electrically conductive layer adjacent location 313. The interconnected nanoparticle material can be formed by applying a solution containing a polymeric linking agent (e.g., poly(n-butyl titanate)) and metal oxide nanoparticles (e.g., titania). In some embodiments, the polymeric linking agent and the metal oxide nanoparticles are separately applied to form the interconnected nanoparticle material. The polymeric linking agent and metal oxide nanoparticles can be heated (e.g., in an oven present in the system used in the roll-to-roll process) to form the interconnected nanoparticle material.

One or more dyes are then applied to the interconnected nanoparticle material adjacent location 335 to form a patterned photoactive layer. The dye(s) can be applied using known methods, including those noted above. In some embodiments, different dyes are simultaneously applied to the interconnected nanoparticle material (e.g., using ink jet printing). In certain embodiments, multiple stations are used, with a different dye being applied to the interconnected nanoparticle material (e.g., using ink jet printing) at each station. Combinations of these methods can also be used.

A charge carrier layer is deposited onto the patterned photoactive layer adjacent location 316. The charge carrier layer can be deposited using known techniques, such as those noted above.

An electrically conductive layer 360 (e.g., ITO) is attached to substrate 370 adjacent location 319.

A catalyst layer precursor is deposited on electrically conductive layer 360 adjacent location 318. The catalyst layer precursor can be deposited on electrically conductive layer 360 using, for example, electrochemical deposition using chloroplatinic acid in an electrochemical cell, or pyrolysis of a coating containing a platinum compound (e.g., chloroplatinic acid). In general, the catalyst layer precursor can be deposited using known coating techniques, such as spin coating, dip coating, knife coating, bar coating, spray coating, roller coating, slot coating, gravure coating, screen coating, and/or ink jet printing. The catalyst layer precursor is then heated (e.g., in an oven present in the system used in the roll-to-roll process) to form the catalyst layer. In some embodiments, electrically conductive material 360 can be at least partially coated with the catalyst layer before attaching to advancing substrate 370. In certain embodiments, the catalyst layer is applied directly to electrically conductive layer 360 (e.g., without the presence of a precursor).

While certain embodiments have been described, other embodiments are possible.

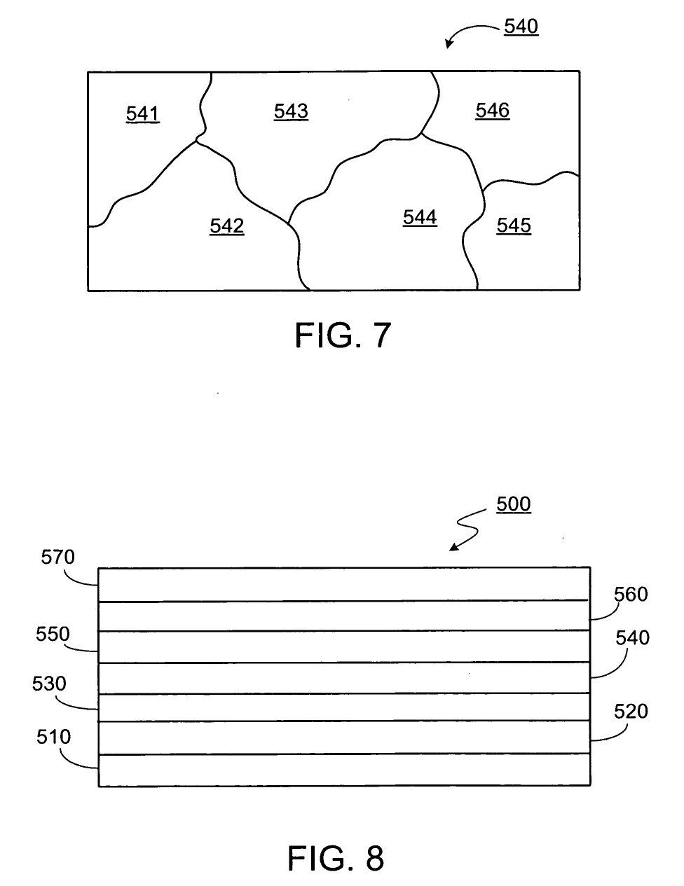

As an example, while embodiments of patterned DSSCs have been described, other types of patterned photovoltaic cells (e.g., patterned polymer organic photovoltaic cells) are also possible. For example, FIG. 7 is a top view of a photoactive layer 550 of an organic photovoltaic cell 500, and FIG. 8 is a cross-sectional view of cell 500. Cell 500 includes a transparent substrate 510, a cathode 520, a hole carrier layer 530, a photoactive layer 540 (containing an electron acceptor material and an electron donor material), a hole blocking layer 550, an anode 560, and a substrate 570.

Photoactive layer 540 includes multiple regions 541-546. Two or more of the different regions of photoactive layer 540 can each include a different polymer composition as the electron donor material within that region. At least two (e.g., at least three, at least four, at least five) of the polymer compositions have a different color so that cell 500 appears patterned (e.g., having one of the patterns noted above). Examples of polymer compositions include discotic liquid crystal polymers, polythiophenes, polyphenylenes, poly(phenylene-vinylene)s, polythienylvinylenes, polyisothianaphthalenes, and combinations thereof.

Examples of the electron acceptor materials that can be used in photoactive layer 540 include fullerenes, inorganic nanoparticles (e.g., nanoparticles formed of zinc oxide, tungsten oxide, indium phosphide, cadmium selenide and/or lead sulphide), oxadiazoles, discotic liquid crystals, carbon nanorods, inorganic nanorods (e.g., nanorods formed of zinc oxide, tungsten oxide, indium phosphide, cadmium selenide and/or lead sulphide), or polymers containing moieties capable of accepting electrons or forming stable anions (e.g., polymers containing CN groups or polymers containing CF₃ groups), and combinations thereof. In some embodiments, at least some of the polymer dyes in photoactive layer 540 have a different color. For example, photoactive layer 540 can include at least three polymer dyes, each having a different color. In certain embodiments, each of the polymer dyes has a different color.

Examples of organic photovoltaic cells are described, for example, in U.S. Patent Application Publication No. 2004/0187911, and co-pending commonly owned U.S. Ser. No. 60/576,033, both of which are hereby incorporated by reference. Multiple organic photovoltaic cells can be electrically connected (e.g., as described above).

In some embodiments, two photovoltaic cells in a module described above can share a common electrode, also known as tandem photovoltaic cell. Examples of tandem photovoltaic cells are discussed in U.S. patent application Ser. No. 10/558,878 and U.S. Provisional Application Ser. Nos. 60/790,606, 60/792,635, 60/792,485, 60/793,442, 60/795,103, 60/797,881, and 60/798,258, the contents of which are hereby incorporated by reference.

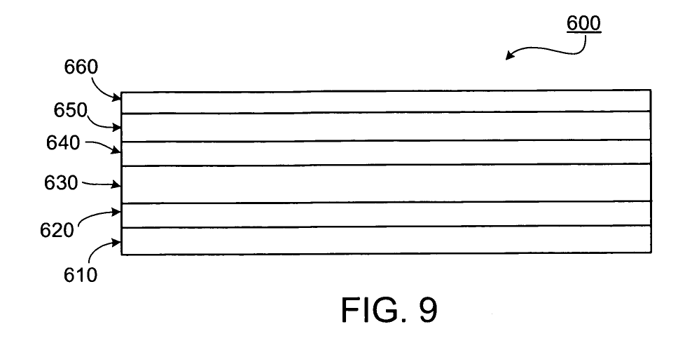

As an example, FIG. 9 is a schematic of a tandem photovoltaic cell 600 having a substrate 610, three electrodes 620, 640, and 660, and two photoactive layers 630 and 650. Electrode 640 is shared between photoactive layers 630 and 650, and is electrically connected with electrodes 620 and 660. In general, electrodes 620, 640, and 660 can be formed of an electrically conductive material, such as those described in U.S. patent application Ser. No. 10/723,554. In some embodiments, one or more (i.e., one, two, or three) electrodes 620, 640, and 660 is a mesh electrode. In some embodiments, one or more electrodes 620, 640, and 660 is formed of a semiconductive material. Examples of semiconductive materials include titanium oxides, indium tin oxides, fluorinated tin oxides, tin oxides, and zinc oxides. In certain embodiments, one or more (i.e., one, two, or three) electrodes 620, 640, and 660 are formed of titanium dioxide. Titanium dioxide used to prepare an electrode can be in any suitable forms. For example, titanium dioxide can be in the form of interconnected nanoparticles. Examples of interconnected titanium dioxide nanoparticles are described, for example, in U.S. Pat. No. 7,022,910, the contents of which are incorporated herein by reference. In some embodiments, at least one (e.g., one, two, or three) of electrodes 620, 640, and 660 is a transparent electrode. As referred to herein, a transparent electrode is formed of a material which, at the thickness used in a photovoltaic cell, transmits at least about 60% (e.g., at least about 70%, at least about 75%, at least about 80%, at least about 85%, at least about 90%, at least about 95%) of incident light at a wavelength or a range of wavelengths used during operation of the photovoltaic cell. In certain embodiments, both electrodes 620 and 660 are transparent electrodes.

Each of photoactive layers 630 and 650 can contain at least one semiconductive material. In some embodiments, the semiconductive material in photoactive layer 630 has the same band gap as the semiconductive material in photoactive layer 650. In certain embodiments, the semiconductive material in photoactive layer 630 has a band gap different from that of the semiconductive material in photoactive layer 650. Without wishing to be bound by theory, it is believed that incident light not absorbed by one photoactive layer can be absorbed by the other photoactive layer, thereby maximizing the absorption of the incident light.

In some embodiments, at least one of photoactive layers 630 and 650 can contain an electron acceptor material (e.g., a fullerene) and an electron donor material (e.g., a polythiophene). In general, suitable electron acceptor materials and electron donor materials can be those described above. In certain embodiments, each of photoactive layers 630 and 650 contains an electron acceptor material and an electron donor material.

Substrate 610 can be formed of one or more suitable polymers, such as those described above. In some embodiments, an additional substrate (not shown in FIG. 9) can be disposed on electrode 660.

Photovoltaic cell 600 can further contain a hole carrier layer (not shown in FIG. 9) and a hole blocking layer (not shown in FIG. 9).

While certain embodiments have been disclosed, other embodiments are possible.

As an example, in some embodiments, one or more of the photovoltaic cells can be amorphous silicon photovoltaic cells.

As another example, a module can include photovoltaic cells that are connected in series, in parallel, or a combination thereof.

The following examples are illustrative and not intended to be limiting.

### EXAMPLE 1

A photovoltaic array similar to the one shown in FIG. 1 is used to recharge a high capacity military rechargeable battery. The array contains three modules, each of which includes 11 photovoltaic cells. The array has a thickness of less than 0.038 cm, a length of 91.4 cm, and a width of 31.7 cm, and an area of about 2,897 cm² (3.1 ft²). Each photovoltaic cell in the array is 0.7 cm wide and has a V_{oc} (voltage produced by a photovoltaic cell with no external load) of 0.7 V. The electrical interconnect space between two cells is 0.2 cm wide. The electrical interconnect space between two modules and the edge space for electrically connecting an external load are both 0.5 cm wide. The array has a density of 0.05 g/cm² or less (i.e., 0.30 g/in² or less or 0.10 lb/ft² or less).

Table 1 below summarizes certain performance parameters calculated based on the photovoltaic array described above. These parameters are obtained based on the assumptions that (1) 100 mW/cm² solar radiation (1 sun intensity) is available to the photovoltaic array, (2) the photovoltaic array is exposed to 6 hours of direct sunlight, (3) 80% of available solar radiation is absorbed by the photovoltaic array, and (4) the photovoltaic array has a 30% reduction in V_{oc} when an external load is present.

For example, since each photovoltaic cell has a V_{oc} of 0.7 V, the V_{oc} of the photovoltaic array is about 16.2 V (i.e., 0.7 V×33×70%=16.2 V). As another example, an array having an efficiency of 5% has energy density per day of 86.4 J/cm² (i.e., 100 mW/cm²×6 hrs×3600 s/hr×5%×80%)=86,400 mJ/cm²=86.4 J/cm²) or about 557 Joules/in². The area of the array is about 2,897 cm² (i.e., 91.4 cm×31.7=2,897 cm²). Thus, the energy generated by such an array is calculated to be about 68 Whr (i.e., 86.4 J/cm²×2,897 cm²=250 kJ=70 Whr). Its power density per hour is about 3.79 W/hr ft² (i.e., 70 Whr÷6 hrs÷3.1 ft²=3.76 W/hr·ft²). Its current density is therefore about 0.232 amps/hr·ft² (i.e., 3.76 W/hr·ft²÷16.2V=0.234 amps/hr·ft²).

TABLE 1
Module Performance Parameters

| Array | Energy | Energy | Power | Current |
|---|---|---|---|---|
| Efficiency | Density | Density | Density | Density |
| (%) | (Joules/cm²) | (Joules/in²) | (W/hr · ft²) | (amps/hr · ft²) |
| 5 | 86.4 | 557 | 3.74 | 0.231 |
| 6 | 104 | 671 | 4.49 | 0.278 |
| 7 | 121 | 780 | 5.23 | 0.323 |
| 8 | 138 | 890 | 5.97 | 0.369 |
| 9 | 156 | 1007 | 6.74 | 0.416 |
| 10 | 173 | 1116 | 7.48 | 0.462 |

### EXAMPLE 2

The data listed in Table 1 are used to evaluate the array size, weight, and power required for recharging two types of batteries: (1) a LI-7 battery that has a 7.63 Ahr capacity, and (2) a battery has a capacity of 13 Ahr, which can be incorporated into a distributed sensor system.

TABLE 2
Summary of array area and weight data for recharging
LI-7 Battery at high (1 hour) and low rates (6 hour)^{a}

| | | LI-7 Battery (7.63 Ahr) | | LI-7 Battery (7.63 Ahr) | |
|---|---|---|---|---|---|
| | | Array Area | | Array Area | |
| Array | Power | (ft²) | Array | (ft²) | Array |
| Efficiency | Density | 1 hour | Wt | 6 hour | Wt |
| (%) | (W/ft²) | recharge | (lb)^{b} | recharge | (lb)^{b} |
| 5 | 3.74 | 33.0 | 3.30 | 5.51 | 0.551 |
| 7 | 5.23 | 23.6 | 2.36 | 3.94 | 0.394 |
| 10 | 7.48 | 16.5 | 1.65 | 2.75 | 0.275 |

^{a}assuming completely discharged batteries are used
^{b}assuming the array has a density of 0.1 lb/ft²

TABLE 3
Summary of array area and weight data for recharging a higher
capacity battery at high (1 hour) and low rates (6 hour)^{a}

| | | Distributed Sensor | | Distributed Sensor | |
|---|---|---|---|---|---|
| | | Battery (13 Ahr) | | Battery (13 Ahr) | |
| | | Array Area | | Array Area | |
| Array | Power | (ft²) | Array | (ft²) | Array |
| Efficiency | Density | 1 hour | Wt | 6 hour | Wt |
| (%) | (W/ft²) | recharge | (lb)^{b} | recharge | (lb)^{b} |
| 5 | 3.76 | 56.0 | 5.60 | 9.30 | 0.93 |
| 7 | 5.23 | 40.2 | 4.02 | 6.71 | 0.671 |
| 10 | 7.48 | 28.1 | 2.81 | 4.69 | 0.469 |

^{a}assuming completely discharged batteries are used
^{b}assuming the array has a density of 0.1 lb/ft²

Tables 2 and 3 respectively summarize the area and weight data of the array required to recharge batteries (1) and (2) at fast and slow rates. The results show that the larger the battery capacity, the larger the area of the array required for recharging. The results also show that the higher the recharge rate for any given battery, the larger the area of the array required.

### EXAMPLE 3

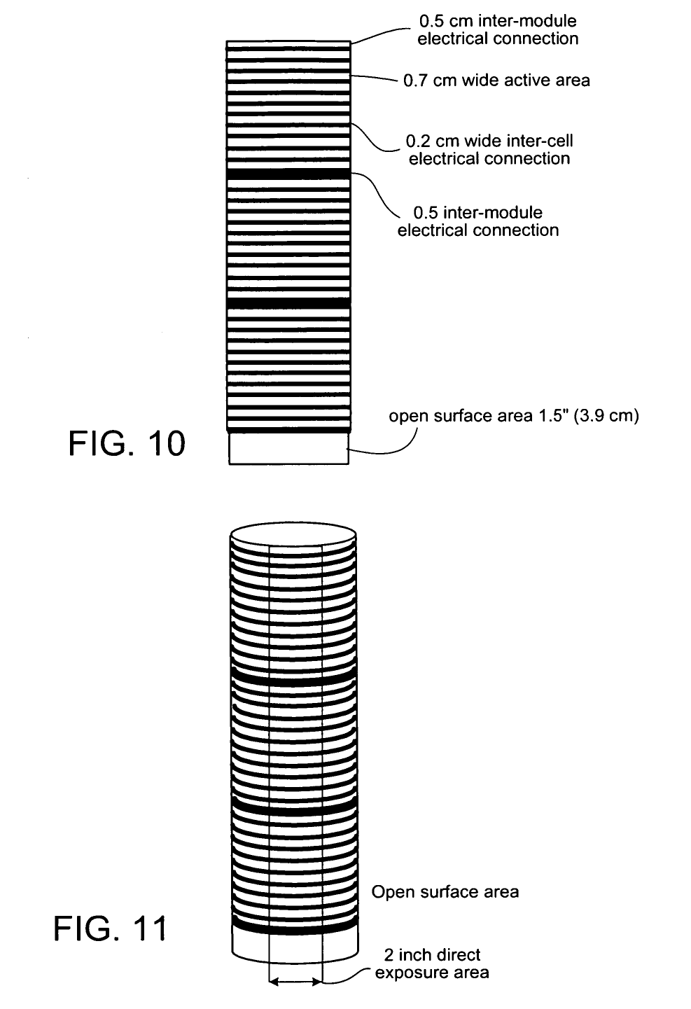

FIG. 10 shows a 3-module photovoltaic array disposed on the outer surface of a housing of a lamp. The housing is a cylinder having a length of 14″ (35.6 cm), a diameter of 5″ (12.7 cm), a circumference 15.7″ (39.9 cm), and a surface area of about 220 in² (1,419 cm²). The lamp has a voltage requirement of 14 V (DC), a power requirement of 5.18 Whrs/day with 6 hours of sunlight/day, a nominal battery capacity of 13 Ahr at a current of 15 mA, and impact resistance of 1,300 G.

The photovoltaic array used in this example is similar to that described in Example 1 except that its length is reduced from 91.4 cm to 39.9 cm. The array has two inter-module interconnect spaces (0.5 cm each) and two edge spaces for electrically connecting an external load (0.5 cm each). Thus, the overall width of the array is 31.7 cm. Since the length of the cylindrical housing is 35.6 cm, there is a space with a length of 3.9 cm (1.5″) on the outer surface that is not covered by the array.

The array having an efficiency of 5% has energy density of 108 J/cm²·day (i.e., 100 mW/cm²×6 hrs×3600 s/hr×5%=108 J/cm²·day). Note that this energy density is calculated based on the entire array, taken into account the effect of the inactive areas between the photovoltaic cells (e.g., electrical interconnect space between two cells, electrical interconnect space between two modules, and the edge space for electrically connecting an external load).

The area of the array is about 1,257 cm² (i.e., 31.5 cm×39.9 cm=1,257 cm²). Assuming that, during the 6-hour exposure, only a 2″ (5.08 cm) long segment of the array is exposed to direct sunlight (see FIG. 11). Thus, the direct exposure area of the array is about 160 cm² (i.e., 5.08 cm×31.5 cm=160 cm²). The energy generated by this direct exposure area is about 13,826 J (i.e., 108 J/cm²×80%×160 cm²)=13,826 J.

For the purpose of this Example, we assume that the remainder of the array utilizes only 20% of the available solar radiation as diffuse light. We also assume that the area on the opposite face of the cylindrical housing from the direct exposure face and the area immediately abutting the segment receiving direct sunlight are exposed to the same level of diffuse radiation. Note that the 20% figure for the backside of the array is appropriate according to industry guidelines, but underestimates the output from the area abutting the area exposed to direct sunlight. Based on these assumptions, the energy output from the area exposed to diffuse radiation is about 23,695 J/day (i.e., 108 J/cm²·day×20%×(1,257 cm²−160 cm²)=23,695 J/day). Thus, the estimated total energy output of the cylinder array is about 37,521 J/day (i.e., 13,826 J/day+23,695 J/day=37,521 J/day) or about 10.4 Whr/day (i.e., 37,521 J/day×hr/3600 s)=10.4 Whr/day), which is about twice the energy required to power the lamp (5.18 Whr/day).

If only diffuse radiation is used in the above calculation, which is a slight underestimate of cloudy day conditions, then the output of the array is about 27,151 J/day (i.e., 108 J/cm²·day×20%×1,257 cm²)=27,151 J/day) or about 7.54 Whr/day, which still exceeds the energy required to power the lamp.

Other embodiments are in the claims.

What is claimed is:

1. A device, comprising:
a housing having a curved outer surface; and
a flexible photovoltaic module disposed on at least a portion of the curved outer surface of the housing;
wherein the device is an illuminating device.

2. The device of claim 1, wherein the housing is cylindrical.

3. The device of claim 1, wherein the flexible photovoltaic module comprises a flexible substrate.

4. The device of claim 3, wherein the flexible substrate has a flexural modulus of less than about 5,000 megaPascals.

5. The device of claim 3, wherein the flexible substrate comprises a polymer selected from the group consisting of polyethylene terephthalates, polyethylene naphthalates, polyethylenes, polypropylenes, polyamides, polymethacrylates, polycarbonates, polyurethanes, and combinations thereof.

6. The device of claim 1, wherein the flexible photovoltaic module comprises a plurality of photovoltaic cells, at least some of which are electrically connected.

7. The device of claim 6, wherein the flexible photovoltaic module comprises a plurality of dye sensitized photovoltaic cells.

8. The device of claim 7, wherein at least some of the plurality of dye sensitized photovoltaic cells comprise titania.

9. The device of claim 6, wherein at least some of the plurality of photovoltaic cells comprise amorphous silicon.

10. The device of claim 6, wherein at least some of the plurality of photovoltaic cells comprises organic photovoltaic cells.

11. The device of claim 6, wherein at least some of the plurality of photovoltaic cells comprises tandem photovoltaic cells.

12. The device of claim 1, wherein the flexible photovoltaic module comprises a plurality of dyes arranged in a pattern.

13. The device of claim 12, wherein at least some of the plurality of dyes have a different color.

14. The device of claim 12, wherein the pattern comprises a camouflage pattern or a logo pattern.

15. The device of claim 1, wherein the flexible photovoltaic module has an efficiency of at least about 5%.

16. The device of claim 1, wherein the flexible photovoltaic module has an efficiency of at least about 7%.

17. The device of claim 1, wherein the flexible photovoltaic module has an efficiency of at least about 10%.

18. The device of claim 1, further comprising a rechargeable battery in the housing.

19. The device of claim 18, wherein the flexible photovoltaic module is configured to recharge the rechargeable battery.

20. The device of claim 1, wherein the device comprises a portable lamp, a flashlight, a lantern, a signage, a landscape light, a buoy light, or a traffic light.
